(19) United States
(12) Patent Application Publication
(10) Pub. No.: US 2010/0048378 A1
(43) Pub. Date: Feb. 25, 2010

(54) SINTERED POLYCRYSTALLINE YTTRIUM ALUMINUM GARNET AND USE THEREOF IN OPTICAL DEVICES

(75) Inventors: Yin Tang, Ann Arbor, MI (US); Anthony C. Sutorik, Milan, MI (US); Long Nguyen, Ann Arbor, MI (US); Lizhi Liu, Ann Arbor, MI (US); Chris Zyskowski, Ann Arbor, MI (US)

Correspondence Address: GIFFORD, KRASS, SPRINKLE,ANDERSON & CITKOWSKI, P.C, PO BOX 7021, TROY, MI, 48007-7021, US

(73) Assignee: NANOCEROX, INC., Ann Arbor, MI (US)

(21) Appl. No.: 12/528,382

(22) PCT Filed: Apr. 24, 2008
(86) PCT No.: PCT/US2008/061407

§ 371 Date: Aug. 24, 2009

Related U.S. Application Data
(60) Provisional application No. 60/913,564, filed on Apr. 24, 2007.

(51) Int. Cl. C04B 35/16; C04B 35/505

(52) U.S. Cl. 501/133; 501/152

(57) ABSTRACT

A transparent yttrium aluminum garnet precursor composition is provided that includes a plurality of calcined particles of yttrium aluminum oxide having a mean particle domain size of between 10 and 200 nanometers and a predominant hexagonal crystal structure. High levels of YAG transparency are obtained for large YAG articles through control of the aluminum:yttrium atomic ratio to 1:06±0.001 and limiting impurity loadings to less than 100 ppm. The composition is calcined at a temperature between 700° Celsius and 900° Celsius to remove organic additives to yield a predominant metastable hexagonal phase yttrium aluminum oxide nanoparticulate having an atomic ratio of aluminum: yttrium of 1:0.6±0.001. With dispersion in an organic binder and a translucent YAG article is formed having a transmittance at a wavelength of 1064 nanometers of greater than 75%. The translucent YAG article is characterized by an average domain size of less than 1 micron and having a density of at least 99% and inclusions present at less than 2 surface area percent. The ability of a batch of yttrium aluminum oxide nanoparticles to serve as a transparent YAG precursor includes collecting an X-ray fluorescence spectrum from a plurality of aluminum oxide nanoparticles having a predominant crystal structure other than garnet to yield an A1:Y raw integrated peak intensity ratio. The nanoparticles are sintered to yield a predominant garnet phase and a secondary phase and optionally isostatic pressing during sintering. By using only precursor nanoparticles with a standard deviation of ±0.003 in the peak ratio exceptionally high transparency YAG is reproducibly produced.

### RELATED APPLICATION

This application claims priority of U.S. Provisional Patent Application Ser. No. 60/913,564 filed Apr. 24, 2007, which is incorporated herein by reference.

### FIELD OF THE INVENTION

The present invention relates to polycrystalline yttrium aluminum garnet (“YAG”) manufactured by sintering of nanoparticles of yttrium aluminum oxide of defined composition, and in particular to optical elements employing the polycrystalline YAG.

### BACKGROUND OF THE INVENTION

Crystalline yttrium aluminum garnet (Y₃Al₅O₁₂) exists in a cubic form and has a garnet structure. YAG ceramics are characterized by high melting point, excellent chemical stability, and creep resistance. YAG (Y₃Al₅O₁₂) materials in various forms have proven useful for many diverse applications. For example, Ce³⁺ doped YAG is a phosphor used for fast response scanners; doping with other rare earth metals, such as Pr, Er, Eu, Yb and Nd, into YAG makes it an ideal host material for solid-state lasers, which have attracted both technological and industrial interest. YAG single crystals are normally synthesized by the Czochralski method. However, YAG single crystals are expensive, and it is difficult to produce large size YAG single crystals to satisfy many use applications.

In recent years, considerable effort has been expended in synthesizing transparent polycrystalline YAG ceramics. Transparent polycrystalline YAG ceramics have the advantages of lower cost, ease of manufacture and mass production, the possibility of making large-sized parts, and the possibility of the incorporation of Q-switching and Raman shifting within the source. The synthesis of transparent YAG ceramics has proven to be technically quite difficult.

A polycrystalline transparent YAG was first made by Ikesue and coworkers in 1995 even though the optical transmission attainable was low. A. Ikesue, I. Furusato, K. Kamata, J. Am. Ceram. Soc., 78(1) (1995), 225-228. Previously only translucent samples (i.e., opaque bodies with high scattering) had been reported in the literature. (a) G. de With, H. J. A. van Dijk, Mater. Res. Bull., 19 (1984), 1669-1674. (b) C. A. M. Mulder, G. de With, Sol. St. Ionics, 16 (1985), 81-86. (c) G. de With, Phillips J. Res., 42 (1987), 119-130. M. Sekita, H. Haneda, T. Yanagitani, S. Shirasaki, J. Appl. Phys., 67 (1990), 453-458. This earlier work followed several procedures which were similar to those which would come later. Starting powders of “stoichiometric” YAG composition (Al:Y atomic ratio of 1:0.6) were coprecipitated from solutions of the metal ions. SiO₂ was added as a sintering aid, and after calcination at −1300° C., samples were vacuum sintered at 1450° C. for 8 h and 1850° C. for 8 h. (a) G. de With, H. J. A. van Dijk, Mater. Res. Bull., 19 (1984), 1669-1674. (b) C. A. M. Mulder, G. de With, Sol. St. Ionics, 16 (1985), 81-86. (c) G. de With, Phillips J. Res., 42 (1987), 119-130. Analysis of the resulting translucent samples with microscopy invariably revealed the presence of Al rich precipitates (presumably Al₂O₃) which had phase separated upon sintering. These Al rich precipitates were the primary cause of optical scattering and sample opacity.

What has become apparent since the Ikesue breakthrough in YAG is that three critical criteria have to be maintained in order to achieve transparency: namely the purity of the starting materials must be ≧99.99% for all the elements which could induce scatter and/or absorption of the laser; the Y/Al ratio must be near exact stoichiometry (0.6±0.001); and residual porosity must be on the ppm level.

To ensure sufficient purity in the starting powders, Ikesue and coworkers prepared their own Al₂O₃ and Y₂O₃ from alkoxide precipitation and oxychloride decomposition, respectively. Carefully isolated and characterized powders were weighed in stoichiometric amounts and dispersed in ethanol with unspecified binder and 0.6 wt % Si(OC₂H₅)₄ (which hydrolyzes to amorphous SiO₂ to serve as a sintering aid). The slurry is milled and spray dried. The collected powder is dry pressed and cold isostatically pressed (CIPed) into a green body. Sintering occurs under high vacuum (<10⁻⁵ torr) at temperatures of 1750-1850 for ˜20 h. Two hours of sintering is sufficient for high transmission, but to further reduce scattering to “optical grade” levels (i.e., <0.9%/cm), isotherms of 10-20 h are necessary. The grain sizes in these final parts are typically 10-30 μm. Subsequent efforts adapted these procedures to include various dopants including Nd³⁺ and Cr³⁺ with retaining optical transmissivity (Progress in ceramic lasers, Ikesue et al., Ann. Rev. Mater. Res., 36: 397-429 2006; Transparent Cr4+-doped YAG ceramics for tunable lasers, Ikesue et al., J. Am. Ceram. Soc. 79 (2): 507-509 February 1996; Scattering in polycrystalline Nd:YAG lasers, Ikesue et al. J. Am. Ceram. Soc. 81 (8): 2194-2196 August 1998). The mechanisms and processing steps were recently studied in more detail by Lee, et al., who were able to achieve high transparency and low scatter with commercially available, high purity oxides and a simplified processing procedure. S.-H. Lee, S. Kochawattana, G. L. Messing, J. Dumm, G. Quarles, V. Castillo, J. Am. Ceram. Soc., 89 (2006), 1945-1950. The importance of the key issues of purity, stoichiometry, and pore removal were confirmed.

The above detailed successes initiated new efforts in pursuant of transparent YAG with a variety of synthetic strategies. Rather than the reactive sintering approach of Ikesue (in which separate oxides undergo solid-state reaction coincident with sintering), many researchers have sought to make improvements by preparing single source starting powders by coprecipitation from solutions with Y³⁺ and Al³⁺ ions in the necessary stoichiometric ratio. The thesis is that such powder precursors may lead to greater sinterability, finer grain sizes in the final ceramic, and a simpler methodology for compositional control. Reported procedures have made use of alkoxide hydrolysis ((a) T. A. Parthasarathy, T. Mah, K. Keller, J. Am. Ceram. Soc., 75 (1992), 1756-1759. (b) M. Steinmann, G. de With, Euro-Ceramics, Vol. I, Processing of Ceramics, Maastricht, the Netherlands, (1989) p.1109-1113. (c) O. Yamaguchi, K. Takeoka, A. Hayashida, J. Mat. Sci. Lett., 10 (1990), 101-105) or controlled basic precipitation of aqueous cation salts. (a) J.-G. Li, T. Ikegami, J.-H. Lee, T. Mori, J. Am. Ceram. Soc., 83 (2000), 961-963. (b) T. Tachiwaki, M. Yoshinaka, K. Hirota, T. Ikegami, O. Yamaguchi, Sol. St. Commun., 119 (2001), 603-606. (c) N. Matsushita, N. Tsuchiya, K. Nakatsuka, T. Yanagitani, J. Am. Ceram. Soc., 82 (1999), 1977-1984. (d) L. Wen, X. Sun, Z. Xiu, S. Chen, C.-T. Tsai, J. Euro. Ceram. Soc., 24 (2004), 2681-2688. The later, as practiced by Lu et al. (J. Lu, K. Ueda, H. Yagi, T. Yanagitani, Y. Akiyama, A. A. Kaminskii, J. Alloys Comp., 341 (2002), 220-225.), serves as the basis for the world's only commercial source of finished, laser-quality YAG ceramics from Konoshima in Japan, U.S. Pat. Nos. 6,825,144 and 6,200,918. The mixed powders are initially produced via coprecipitation with NH₄HCO₃ solutions. The solid is collected by filtration and calcined at 1200° C. Also, rather than dry pressing, slip-casting procedures were developed to fabricate large green bodies of a variety of sizes and shapes. Following casting and low temperature binder burn-out, sintering is performed under high vacuum at 1750° C. for 5-20 h. Despite differences in powder synthesis, all of these routes still rely on sintering under high vacuum at temperatures >1700° C. for tens of hours and are usually supplemented by a separate hot isostatic pressure (HIP) treatment. An example of YAG powders with enhanced sinterability can be found in the work of Mah et al. T.-I. Mah, T. A. Parthasarathy, H. D. Lee, J. Ceram. Process. Res., 5 (2004), 369-379. Mah et al. used a batchwise combustion synthesis approach to generate high surface area, nanoparticle starting powders. Following a mild calcining at 1000-1100° C., powders were milled with a binder and Si(OC₂H₅)₄ sintering aid, dried, pressed and air sintered at a relatively modest 1550-1650° C. for 5 h. The translucent samples are then treated by HIP at 1450-1550° C. for 5 h under 200 MPa Ar for 5 h to achieve final pore elimination and high transparency.

These and other reports in the open literature consistently convey the feasibility of producing highly transparent YAG from various methods as long as the three criteria of high purity, composition control, and complete pore elimination are attained. The ease at finding such reports may leave one with the impression that many of the issues of preparing transparent YAG are largely solved. Although the basic requirements have been identified, they are, in fact, so stringent that batch-to-batch consistency remains one of the significant challenges yet facing the continued commercial development of transparent YAG. Possibly the parameter most difficult to control is the stoichiometry. Deviations of ±0.001% from ideal stoichiometry can lead to the formation of either Y- or Al-rich precipitates within a sintered YAG ceramic. Although below the detection limit of most analytical techniques, these precipitates still significantly lower optical transmission because of the very sensitive nature of light scattering to second phase impurities with different refractive indices.

The YAG-based ceramic laser materials, compared to YAG single crystal materials, are extremely useful because of easiness in fabrication of desired shape and size, high concentration doping, multi-functionality, and above all inexpensive for mass production. However, the key point remains in the fabrication of large-scale superior quality powders of these materials, displaying novel optical properties that affect the emission lifetime, luminescent quantum efficiency, and concentration quenching for advanced phosphor and photonic applications. In addition, it is important to devise inexpensive chemical route to synthesize reliable and stable powders to optimize the ceramic processing to obtain high quality materials.

Recently, nanotechnology has made it possible to produce polycrystalline YAG transparent ceramic from yttrium aluminum oxide (YAO) nanoparticulate by flame synthesis, as detailed in WO 03/070640 that have in part addressed these problems, yet high quality transparent YAG remains a difficult material to produce.

Thus, there exists a need in the art to form transparent polycrystalline YAG elements and to produce optical elements therefrom.

### SUMMARY OF THE INVENTION

A transparent yttrium aluminum garnet precursor composition is provided that includes a plurality of calcined particles of yttrium aluminum oxide having a mean particle domain size of between 10 and 200 nanometers and a predominant hexagonal crystal structure. High levels of YAG transparency are obtained for large YAG articles through control of the aluminum:yttrium atomic ratio to 1:06±0.001 and limiting impurity loadings to less than 100 ppm. The composition is calcined at a temperature between 700° Celsius and 900° Celsius to remove organic additives to yield a predominant metastable hexagonal phase yttrium aluminum oxide nanoparticulate having an atomic ratio of aluminum:yttrium of 1:0.6±0.001. With dispersion in an organic binder and a translucent YAG article is formed having a transmittance at a wavelength of 1064 nanometers of greater than 75%. The translucent YAG article is characterized by an average domain size of less than 1 micron and having a density of at least 99% and inclusions present at less than 2 surface area percent.

The ability of a batch of yttrium aluminum oxide nanoparticles to serve as a transparent YAG precursor includes collecting an X-ray fluorescence spectrum from a plurality of aluminum oxide nanoparticles having a predominant crystal structure other than garnet to yield an Al:Y raw integrated peak intensity ratio. The nanoparticles are sintered to yield a predominant garnet phase and a secondary phase and optionally isostatic pressing during sintering. By using only precursor nanoparticles with a standard deviation of ±0.003 in the peak ratio exceptionally high transparency YAG is reproducibly produced.

### BRIEF DESCRIPTION OF THE DRAWINGS

FIG. 1 is a scanning electron microscopy (SEM) micrograph of yttrium aluminum oxide (YAO) nanoparticles as synthesized according to the present invention by liquid precursor flame spray pyrolysis;

FIG. 2 is a transmission electron microscopy (TEM) micrograph of the YAO nanoparticles imaged in FIG. 1;

FIG. 3 is an X-ray powder diffraction (XRD) pattern from the YAO nanoparticles of FIG. 1 after calcining at 1200° C. for 1 hour;

FIG. 4A shows XRD patterns for two YAO samples produced from different batches designated “pink” and “black”, each sample calcined at either 600° C. for 2 hours and 1050° C. for 2 hours;

FIG. 4B shows XRD patterns for the samples “pink” and “black” samples of FIG. 4A each calcined at 800° C. for 5 hours and then 1000° C. for 2 h;

FIG. 5 shows XRD patterns for as produced YAO nanoparticles (FIG. 5A) and annealed YAG (FIG. 5B) after 1000° C.

FIG. 6 is a photograph of a translucent YAG disk formed according to the present invention; and

FIG. 7 is a transmittance spectrum for the disk of FIG. 6 showing 83.5% transmission at 1064 nm.

### DETAILED DESCRIPTION OF THE PREFERRED EMBODIMENTS

The present invention has utility as a composition for a translucent yttrium aluminum garnet (YAG) article. Through the production of a polycrystalline YAG article suitable for laser device formation, difficulties associated with growing a YAG crystal with correct stoichiometry and low presence of impurities are overcome. An inventive precursor composition is synthesized and processed so as to inhibit formation of optically light scattering inclusions. Through control of sintering conditions and subsequent processing to full density and high quality optical grade polish, a polycrystalline, transparent YAG article is formed that is particularly well suited for use involving high-energy optical devices.

Additionally, it is appreciated that an inventive Al:Y stoichiometric atomic ratio is maintained at 1:0.6±0.001 in order to achieve stoichiometric YAG having a formula Y₃Al₅O₁₂ having desirable optical transparency. It is appreciated that stoichiometric deviations in the Al:Y atomic ratio away from that of YAG results in the formation of aluminum-rich oxide and/or yttrium-rich oxide inclusions, depending on the excess metal. Aluminum-rich oxide and yttrium-rich oxide are both light scattering materials and decrease the translucency of the resulting YAG article.

A precursor liquid solution is formed by combining a yttrium precursor and an aluminum precursor. The solvent contained within the precursor liquid solution may be alcohol based and capable of being aerosolized into a flame spray pyrolysis reactor in the presence of excess oxygen. The volatile solvent is combusted, and the precursor oxidatively decomposes to produce stoichiometrically correct yttrium aluminum oxide vapors that condense rapidly in the steep temperature gradient to form nanosized particles of yttrium aluminum oxide. The yttrium precursor and the aluminum precursor are each weighted and calculated to ensure a proper Al:Y ratio in the resulting combined liquid solution. Preferably the Al:Y atomic stoichiometry is controlled to 1:0.6±0.001.

The yttrium precursor is prepared by dissolving a reagent in an acidic solvent or solution. Preferably, the acid is an organic acid capable of complexing a yttrium ion. Representative organic acids include acetic acid or propionic acid. The yttrium reagent is virtually without limit, yet is chosen for low impurity levels, good acid dissolution, and optionally the ability to complex in a separable manner from reagent impurities and is selected from the group consisting of yttrium nitrate, oxide or hydroxide. A preferred acid solvent is the propionic acid. High purity yttrium propionate is synthesized using a refluxing method in a flask with water cool condenser. High purity Y₂O₃ with selective size distribution reacts with propionic acid, acetic acid and DI water. High purity yttrium propionate is also synthesized as detailed in U.S. Patent Application Publication 2005/0227864. The resulting yttrium propionate is then mixed with aluminum precursor and solvent for subsequent liquid phase flame spray pyrolysis.

High purity precursors are also prepared through the formation of:

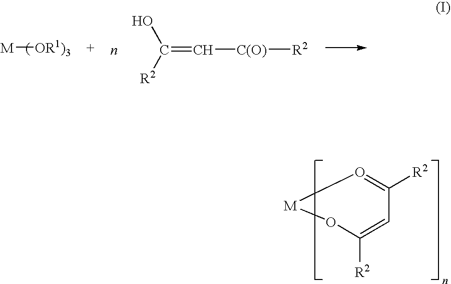

where R¹ in each occurrence independently is a C₁-C₈ alkyl, C₆-C₁₂ cycloalkyl, or C₆-C₁₄ aryl; R² in each occurrence independently is H, C₁-C₈ alkyl, C₆-C₁₂ cycloalkyl, or C₆-C₁₄ aryl; M is a main group or lanthanide metal ion of Al, Ga, In, Tl, Ce, Pr, Nd, Sm, Eu, Gd, Tb, Dy, Ho, Er, Tm, Yb, Zr or Lu; and n is 3 except when M is Zr, then n is 4. Preferably, R¹ is the C₁-C₈ alkyl and more preferably a C₃-C₈ branched alkyl. R² is preferably methyl. The details of this precursor formation are provided in copending U.S. patent application Ser. No. 12/020,851.

After preparation of precursors having limited metal impurities capable of forming inclusions in a full densified YAG article, the yttrium precursor and aluminum precursor are mixed to form a solution with intimate molecular mixing prior to flame spray pyrolysis (FSP). As a result the oxidized YAO particles so produced exhibit a molecular scale Al:Y atomic homogeneity and purity not previously obtainable with conventional inorganic precursors such as nitrates, chlorides, bromides, or oxyhalides of yttrium or aluminum and conventional methods.

Alternatively, a yttrium precursor or aluminum precursor is an organometallic compound such as those conventional to chemical vapor deposition with the proviso that the organometallic dissolves in the FSP solvent containing the other precursor of yttrium or aluminum and volatilization of the organometallic occurs in concert with the other precursor. It is appreciated that an optional dopant to the inventive composition is also readily provided as an organometallic or an acid complex as detailed above.

As used herein, an “organometallic” is defined as a compound having a metal-carbon bond.

A dopant is optionally provided to modify the optical properties of the resultant YAG material and is a common practice in forming lasing crystals. Typical dopant metals include transition metals and lanthanide series metals. According to the present invention, a dopant is added in a quantity that does not induce dopant segregation to form a dopant inclusion crystallite. It is appreciated that thermal processing conditions associated with comparatively longer sintering time and higher temperature are likely to induce dopant migration and inclusion formation. Preferably, a dopant is added in an amount that resides in an interstice of the YAG crystal structure, or the amount of either yttrium or aluminum is reduced and an atomic equivalent of dopant provided as a lattice substituent for the metal present in a reduced quantity. Typical dopant loadings are from 0.001 to several mole percent relative to Y or Al in YAG stoichiometry. The dopant materials are introduced into the precursor system for liquid phase flame spray pyrolysis. High purity dopant precursor is synthesized using a refluxing method in a flask with water cool condenser. High purity oxides with selective size distribution react with propionic acid, and DI water. High purity dopant precursor is also synthesized using the chemical reaction method provided in U.S. patent application Ser. No. 10/503,454 and/or pending U.S. patent application Ser. No. 12/020,851. The dopant materials are also introduced into yttrium aluminum oxide system through processing of yttrium aluminum oxide nanopowder.

A yttrium aluminum oxide nanoparticle having an amorphous or hexagonal crystal structure and a preselected aluminum:yttrium atomic ratio prior to calcination is produced by a variety of conventional techniques. These techniques illustratively include flame pyrolysis, solution precipitation, and high temperature solid state reaction. Liquid phase flame spray pyrolysis represents a particular method of yttrium aluminum oxide particulate synthesis. Feeding such a precursor solution or suspension into a flame affords highly uniform particulates of controlled size and composition. Typical YAO particulate mean particle domain sizes range from 10 to 500 nanometers with the particulates having a generally spherical shape. Control of particulate domain size is exercised through parameters such as precursor solution, suspension feed rate, liquid atomization droplet size, flame dwell time, and flame temperature.

A precursor composition for a polycrystalline YAG article includes calcined yttrium aluminum oxide particles that have a mean particle domain size of between 10 and 500 nanometers. The precursor particles if calcined at a comparatively low temperature of 700 to 900° C. for a duration of a few hours retain a crystal structure in the particles comparable to hexagonal YAlO₃ and without intending to be bound by a particular theory is believed to be a predominant hexagonal phase. Preferably, the mean hexagonal structure yttrium aluminum oxide has a mean particle domain size of between 30 and 200 nanometers. It is appreciated that the hexagonal phase yttrium aluminum oxide may well include secondary amorphous phases or secondary crystal structure forms illustratively including (A_{3/4}B_{1/4})BO₃ where A is Y and B is Al. Additionally, it is appreciated that the aluminum:yttrium stoichiometric atomic ratio is maintained at 1:0.6±0.001 in order to achieve stoichiometric YAG having a formula Y₃Al₅O₁₂. It is appreciated that stoichiometric deviations in the aluminum:yttrium atomic ratio away from that of YAG results in the formation of aluminum-rich oxide or yttrium-rich oxide inclusions, depending on which constituent is present in excess. Aluminum-rich oxide and yttrium-rich oxide act as light scattering center in the bulk YAG article and enhance its opacity.

Optionally, a precursor composition is formulated with a fraction of the yttrium atoms replaced with a metal M¹ where M¹ is Yb, Er, and Nd, Pr, Eu, Ho, or other rare earth element. Similarly, a fraction of the aluminum atoms of YAG are substituted with a metal M² where M is Cr and V, In or trivalent transition metal Additionally, it is appreciated that a portion of yttrium atoms is replaced with M¹ while simultaneously a portion of aluminum atoms are replaced with metal M² to yield a substituted YAG composition having the formulation:

(YM¹)₃(AlM²)₅O₁₂

Such substituent metals are added to modify the magnetic and/or optical properties of the resulting YAG article or provided to suppress formation of aluminum-rich oxide or yttrium-rich oxide inclusion bodies.

A precursor composition is formed by calcining yttrium aluminum oxide nanoparticles with a preselected aluminum:yttrium stoichiometric atomic ratio at a temperature between 700° Celsius and 1300° Celsius. The yttrium aluminum oxide (YAO) particles as synthesized by liquid FPS are noted to by X-ray powder diffraction to possess some amorphous structure with hexagonal crystal structure material. With calcination in the range of 700° C. to ˜900° C., the YAO nanoparticles possess a predominantly hexagonal crystal structure even stronger. With longer duration and/or higher temperature heating the YAO nanoparticles are transformed to a majority garnet crystal structure. It is appreciated that temperature and time needed for crystallographic phase conversion depend on the liquid FPS operating conditions, such as precursors and reactor conditions, average particle size and the thermodynamic activation energy and kinetics for a given phase transformation. A representative calcination results is provided in Table 1.

TABLE 1
XRD result for calcine study.

| Powder calcination | | XRD | Note (for peak intensity) |
|---|---|---|---|
| AP | | H | |
| 800° C.-2 h | | H | |
| 800° C.-2 h | 1000° C.-2 h | H, G, O | H > G, small amount of O |
| Then | 1050° C.-0.5 h | H, G, O | G > H, small amount of O |
| | 1050° C.-2 h | G | |
| 900° C.-2 h | | H | Stronger than 800° C.-2 h |
| | | | and AP powder |
| 900° C.-2 h | 1000° C.-0.5 h | H | Similar to 900° C.-2 h |
| Then | 1000° C.-2 h | H, G, O | H ≈ G, small amount of O |
| | 1050° C.-0.5 h | H, G, O | G > H, small amount of O |
| | 1050° C.-1 h | H, G, O | G >> H, small amount of O |
| | 1050° C.-2 h | G | |
| 1050° C.-1 h | | H, G, O | G >> H, small amount of O |
| 1050° C.-2 h | | G | |

(H—Hexagonal structure, G—garnet structure, O—Orthorhombic structure)

A sensitive analysis procedure based on X-ray fluorescence (XRF) instrumentation (Rigaku ZSX Primus II) is used to overcome the existing difficulties associated with the compositional control of the Al:Y atomic ratio. The procedure is to measure the Al:Y raw integrated peak intensity on batches of as synthesized nanoparticles and then to correlate the raw intensity results with the degree of secondary phase formation observed during sintering. For batches which sinter with little or no secondary phase formation, the XRF results typically fall within a standard deviation value of ±0.003 based on Al:Y peak ratio. YAO nanoparticles demonstrating a XRF result within this error range are indicative of good transparency value in the final YAG densified article.

It is appreciated that the mean particle domain size during calcination increases with calcination temperature. The rate of increase is dependent on the calcination temperature and the time during which the particles are calcined at that temperature. At some point associated with a particular temperature, usually a comparatively higher temperature, a so-called necking phenomenon may be observed where a sudden jump in the size of the particles is observed. The necking phenomenon is indicative of mass transformation between contiguous particles.

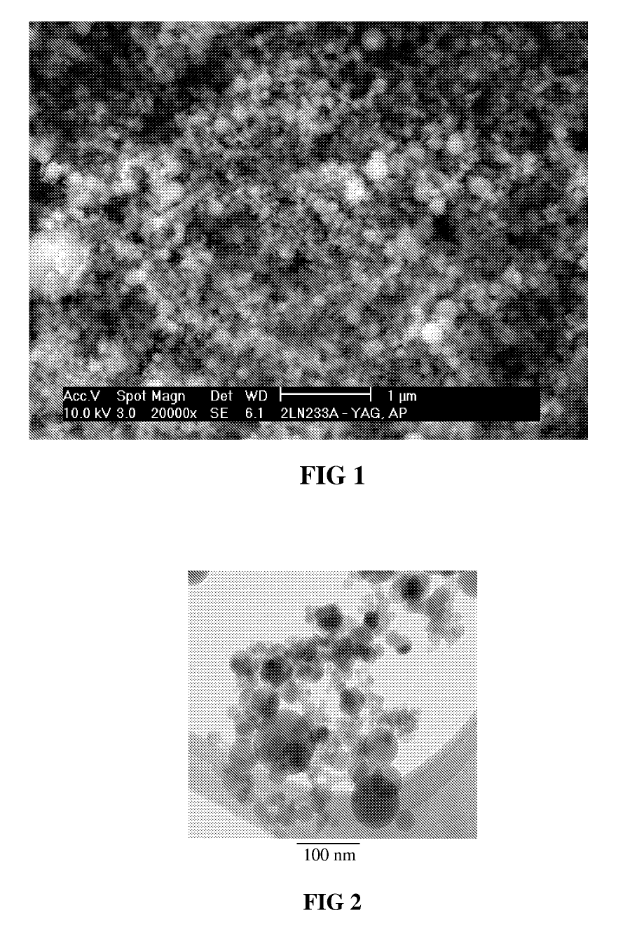

FIG. 1 shows a representative SEM of a representative inventive YAO nanopowder. The average particle size (APS) is estimated from such observations to be ˜50 nm with a low occurrence of large outlying particles. Surface area measurements are used to calculate bulk APS values, as long as it is recognized that the method can be weighted more favorably towards the smallest particles. For YAO nanopowders, surface area measurements are typically 29-35 m²/g which corresponds to an APS (assuming perfectly spherical particles) of ˜42 nm, in good agreement with the microscopy observations. TEM shows a low occurrence of less than 30 particle percent hard interparticle contacts, and necking contacts do occur, the “necking” is limited on average less than 3 neighboring particles as compared to extended fractal patterns of interparticle aggregates, FIG. 2. For the inventive YAO precursor, the dominant particle morphology is spheriodal.

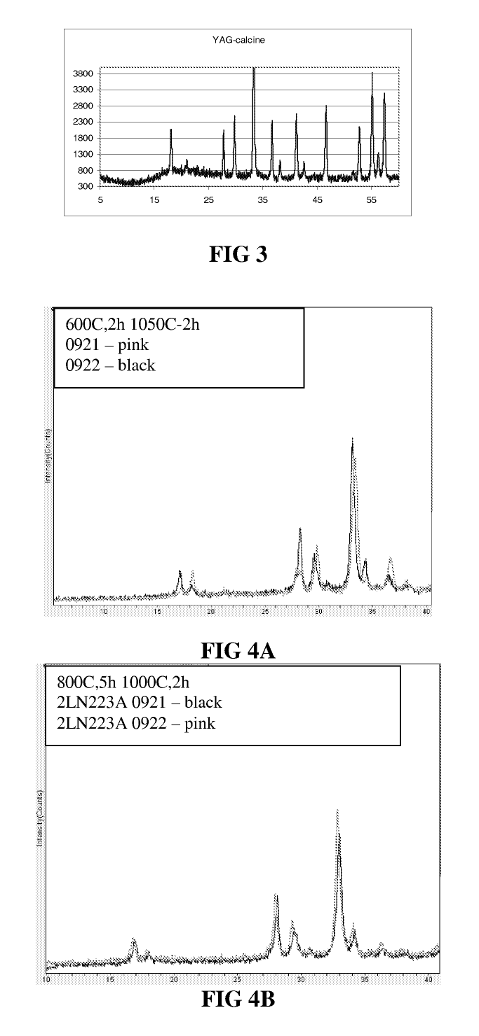

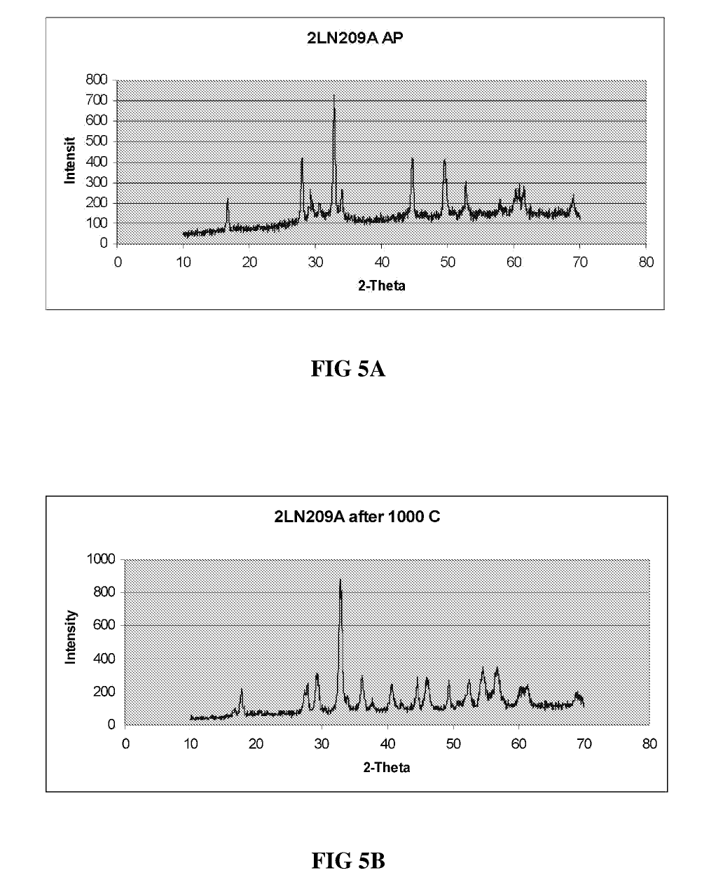

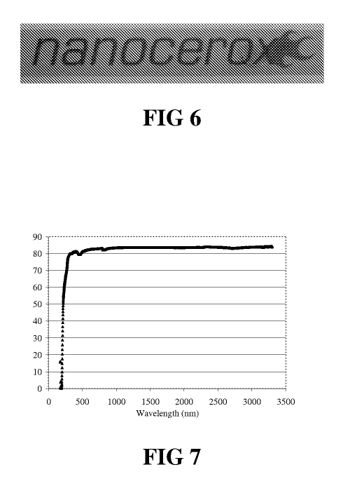

FIG. 3 shows the XRD of YAO nanopowder as produced and after calcining at 1200° C. for 1 h. Due to the rapid thermal quenching from the liquid FSP combustion zone, nanopowders are optionally controlled to be produced in a kinetically stable phase. In the case of YAO, XRD shows a pattern which corresponds to hexagonal YAlO₃. Since the elemental ratio is that of YAG, formation of this structure would require vacancies on the Y site; partial occupation of Al on the Y site, or a combination of both. This hexagonal phase is metastable, and after calcining at 1200° C. for lh, the material fully converts to the cubic garnet structure of YAG.

A representative purity analysis of YAO nanopowder so produced is provided by glow discharge mass spectroscopy (GDMS) in Table 2. The occurrence of color forming transition metals is noted to be low. Although Si is present in a significant amount, the use of Si containing sintering aid at ˜0.6 wt % suggests that this amount of impurity does not significantly affect properties of the resulting transparent ceramic. The other major impurities (Na, Cl, and S) are largely removed by appropriate high temperature calcination of the nanopowder prior to sintering. That leaves the remainder of the impurities at a total of less than 100 ppm and preferably less than 55 ppm by weight for alkali metals, transition metals, and lanthanides. Preferably impurities inclusive of B and P remain at less than 55 ppm. Still more preferably impurities inclusive of B, P, K, Rb and Cs remain at less than 55 ppm.

TABLE 2
YAO nanoparticle impurities detected by GDMS

| ANALYSIS | ppmw |
|---|---|
| H | |
| Li | <0.1 |
| Be | <0.1 |
| B | 0.48 |
| [symbol] | |
| [symbol] | |
| O | Major |
| F | 7.0 |
| Na | 35 |
| Mg | 1.4 |
| Al | Major |
| Si | 25 |
| P | 1.2 |
| S | 30 |
| Cl | 70 |
| K | 2.2 |
| Ca | 10 |
| Sc | <0.05 |
| Ti | 0.35 |
| V | 0.10 |
| Cr | 1.2 |
| Mn | 0.40 |
| Fe | 7.5 |
| Co | <0.1 |
| Ni | 0.14 |
| Cu | 1.2 |
| Zn | 1.7 |
| Ga | 0.50 |
| Ge | |
| As | <1 |
| Se | |
| Br | |
| Rb | |
| Sr | |
| Y | Major |
| Zr | 0.30 |
| Nb | <0.1 |
| Mo | <0.1 |
| Ru | |
| Rh | |
| Pd | |
| Ag | |
| Cd | |
| In | |
| Sn | 0.90 |
| Sb | ≦1 |
| Te | |
| I | |
| Cs | |
| Ba | 0.10 |
| La | 3.5 |
| Ce | 1.5 |
| Pr | 0.40 |
| Nd | 0.80 |
| Sm | 1.3 |
| Eu | 0.20 |
| Gd | 0.30 |
| Tb | 1.0 |
| Dy | 0.30 |
| Ho | 0.30 |
| Er | 0.65 |
| Tm | 0.17 |
| Yb | 0.80 |
| Lu | 0.15 |
| Hf | <0.1 |
| Ta | <10 |
| W | <0.5 |
| Re | |
| Os | |
| Ir | |
| Pt | |
| Au | |
| Hg | |
| Tl | |
| Pb | 0.15 |
| Bi | <0.1 |
| Th | <0.05 |
| U | <0.05 |

The YAO powder is calcined to clean the surface of absorbed species. Phase conversion occurs at high calcination temperature. Non-garnet YAO, partially garnet YAO and garnet structure YAG powders, are all readily processed into high density, uniform green bodies, which are sintered to transparent YAG ceramics. The temperatures of calcination are selected to inhibit premature particle sintering manifest as necking contacts between contiguous particles.

A dispersion of the calcined nanopowder is then prepared in deionized water with dispersant aid (to prevent particle flocculation) and organic binder (to increase the mechanical strength of the green ceramic parts).

It is appreciated that conventional ceramic densification techniques are operative herein to maximize green density of an article formed from the inventive precursor composition. These techniques include the use of a precursor composition particle size distribution theoretically approaching monodisperse, the use of bimodal distributions with modes of sufficiently different sizes such that smaller particles are able to fill interstices between the larger mode particles, and multimodal distributions.

A green body article is formed from a slurry in water or organic solvent of calcined YAO particles. Organic solvents operative herein illustratively include alkyl and aryl, where aryl solvents contain at least carbon atoms: C₁-C₈ alcohols, C₂-C₈ ethers, C₂-C₁₂ ketones or aldehydes, C₃-C₂₀ esters; heterocyclic solvents such as tetrahydrofuran and pyridine. The YAO content of the slurry is typically from 20 to 80 total slurry weight percent and preferably from 30 to 60 total slurry weight percent for granulation, 50 to 80 total slurry weight percent for casting. Typically, the particles have a positive zeta potential upon dispersion in water as a slurry.

Optionally, suitable fugitive binder is added to the slurry. A fugitive binder is defined as a binder or the decomposition products thereof that are removed during pre-firing to greater than 99 weight percent of the binder present. Fugitive binders illustratively include polyvinylpyrrolidones, polyvinyl alcohol, polyacrylates, latexes, and mineral oil. A preferred binder is polyvinyl alcohol. Binders are typically present from 0 to 5 total slurry weight percent for press molding, while casting binders are typically present from 0 to 40 total slurry weight percent. It is appreciated that slurry formation is promoted by sonication, especially in instances where optional additives are provided.

Optionally, a dispersant is also added to the slurry. Dispersants operative herein illustratively include surfactants, with the nature of the surfactant as to nonionic, cationic, or anionic and the hydrophilic-lipophilic balance (HLB) thereof being dictated by factors including the zeta potential of the precursor composition particles, and the nature of the slurry solvent. Water represents a preferred slurry solvent. Ammonium polymethacrylate, fructose, and polyoxyethylene glycol are representative specific dispersants. A dispersant is typically present from 0 to 5 total slurry weight percent. Preferably, a dispersant is selected to improve solid loading for dispersed precursor composition particles. Other conventional additives to a slurry include a thixotrope.

Preferably transparent YAG produced by an inventive procedure includes the typical amount of 0-2 wt % Si(OC₂H₅)₄ to act as a sintering aid. The sintering aid was mixed into the slurry.

The slurry of calcined yttrium aluminum oxide precursor composition particles are preferably filtered through a sieve or other filter media prior to formation of a green body to remove spurious contaminants and excessively large agglomerates of yttrium aluminum oxide that might operate to lessen purity and/or grain density of a resulting article.

An inventive article is formed from a slurry by conventional techniques illustratively including dry pressing, slip casting, and tape casting. For dry pressing, it is appreciated that slurries are preferably subjected to granulation to form a pre-consolidated powder. After mixing and de-agglomeration with sonication, the nanoparticles are reconsolidated through freeze or heat chamber spraying and drying of the slurry. The resulting agglomerates are denser than in the as-produced form and spheriodal in shape. Following these procedures, green bodies of 50-60% final density can be prepared by a combination of uniaxial pressing followed by cold isostatic pressing (CIP). Optionally, cold isostatic pressing is employed to facilitate dimensionally uniform grain body densification. Typical cold isostatic pressing conditions include exertion of 300 megaPascals for 20 minutes.

It is appreciated that in instances where an article is tape casted, that an extrudable tape casting binder is present in a quantity sufficient to allow convenient tape formation. Slip casting and tape casting are appreciated to be article formation techniques well suited for the creation of complex forms and shapes that are especially difficult to form from conventional single crystal YAG.

Sintering of calcined yttrium aluminum oxide particle precursor composition yields an inventive polycrystalline YAG article. Sintering accomplishes the purpose of eliminating any binders and any organics additives at a temperature up to about 700° Celsius, followed by elevated temperature sintering. An exemplary temperature ramp for burnout is 2° C./min to 110° Celsius, hold 1 hours, 1° C./min to 220° Celsius, hold 2 hours, then 0.50 Celsius/min to 450° Celsius, hold 5 hour, then 1° Celsius/min to 650° Celsius. Sintering temperatures range is between 1500° Celsius and 1800° Celsius with the controlled atmosphere and pressure. Sintering typically occurs under <10⁻⁶ torr vacuum at 1650-1750° Celsius for 2-4 hours to yield translucent YAG with >99.5% density, for 6-20 hours to yield transparent YAG with >99.99% density. Hot isostatic pressing (HIP) is used to further enhance the transparency level by reducing residual porosity. The resulting polycrystalline YAG article, optionally in the form of a disc or other optical element blank shape, is then subject to a low temperature annealing at between 1100 and 1400° C. followed by a high-grade optical polish to remove surface imperfections. In contrast to the prior art, YAG transparent articles are readily formed consistently in a variety of forms including discs, plates, and complex three-dimensional shapes having a linear dimension of greater than 5 millimeters and to sizes exceeding 50 millimeters. Furthermore, such articles are reproducibly produced from one batch to another.

Sintering occurs under vacuum, inert atmosphere, in air, and in a reducing atmosphere. Optionally, isostatic pressing to facilitate densification is performed during, or subsequent to sintering. Owing to the tendency of YAG to disproportionate into aluminum-rich oxide domains and yttrium-rich oxide domains upon cooling from a melt, sintering at temperatures approaching the YAG melting temperature is done with care.

The area percentage of an inclusion is determined by measuring the two-dimensional area associated with an inclusion on a given plane of an inventive article. Typically, the plane used for a determination of inclusion area percentage is the flat face of an 8 millimeter diameter pellet formed from an inventive precursor composition. Under these sintering conditions, the mean grain size of YAG domains in a given plane is from 0.5 to 20 microns and preferably between 1 and 5 microns. More preferably, the grain size is between 1 and 3 microns. It is noted that the grain size of the sintered article tends to increase as the precursor's composition calcination temperature increases.

Aluminum-rich oxide and/or yttrium-rich oxide inclusions are present at less than 2 surface area percent of a given surface in order to afford a translucent inventive article. Preferably, the inclusions are present at less than 0.5 surface area percent. Most preferably, the inclusions are present at less than 0.1 surface area percent.

Having generally described this invention, a further understanding may be obtained by reference to certain specific examples which are provided herein for purposes of illustration only and are not intended to be limiting unless otherwise specified.

### Examples

### Example 1

### Yttrium Propionate Precursor Synthesis

A typical procedure begins with putting 100 g Y₂O₃ in a 2 L round-bottom flask. 1000 g propionic acid is added to the flask with 100 g acetic acid and 50 g water. The flask is put into a mantle and the solution is heated to reflux. Usually it takes 18 to 24 hours until the solution is clear, indicating that all yttrium oxide is dissolved to form a soluble propionate. After cooling down, the solution is used immediately or stored in a closed container for later use.

### Example 2

### Lanthanum/Neodymium Propionate Precursor Synthesis

Into a 2 L round-bottom flask 100 g La₂O₃ or Nd₂O₃ or a combination thereof is added. 1000 g propionic acid is added into the flask as well as 100 g water. The flask is put into a mantle and the solution is heated to reflux. Usually it takes 2 to 8 hours until the solution is clear, indicating that all La₂O₃ or Nd₂O₃ or a combination thereof is dissolved to form soluble propionates. After cooling, 100 g of ethyl hexanoic acid (EHA) is added to stabilize the solution. The solution is used immediately or stored in a closed container for later use.

### Example 3

### Gadolinium/Erbium/Thulium/Ytterbium/Lutetium Propionate Precursor Synthesis

Into a 2 L round-bottom flask 100 g Gd₂O₃ or Er₂O₃ or Tm₂O₃ or Yb₂O₃ or Lu₂O₃ or a combination thereof is added. 1000 g propionic acid is added into the flask as well as 100 g water. The flask is put into a mantle and the solution is heated to reflux. Usually it takes 50 to 80 hours until the solution is clear, indicating that all the Gd₂O₃ or Er₂O₃ or Tm₂O₃ or Yb₂O₃ or Lu₂O₃ or a combination thereof is dissolved to form soluble propionates. After cool down, 100 g of ethyl hexanoic acid (EHA) is added to stabilize the solution. Then the solution is used immediately or stored in a closed container for later use.

### Example 4

### YAO Nanoparticle Synthesis

A procedure to synthesize YAO nanoparticles is provided. A measured quantity of Y₂O₃ is dissolved in propionic acid directly per Example 1. This solution is mixed with 574.7 g aluminum acetylacetonate (acac) and 2 kg methanol. Then the flask is washed with propionic acid and methanol for several times. The washed solution is also mixed with original solution. The total methanol used is 4.2 kg and the solution is passed through a conventional L-FSP reactor. The resultant YAO powder is processed as detailed in U.S. patent application Ser. No. 11/399,198 with respect to terbium aluminum oxide particles with an appreciation that processing temperatures are varied for YAO, and air sintered to check the phase separation under SEM. The results show some modest amounts of aluminum or yttrium oxide rich inclusions typically constituting less than 0.5 total volume percent of the YAO powder.

### Example 5

### Cl Impurity Effect on Phase Conversion and Heat Treatment Reduce Cl Impurity Level

YAO powders produced in different batches may exhibit various Cl impurity levels based on reagent sources. Heating temperature and heating time also modify the Cl impurity levels and hence the phase transformation efficiencies thereafter. FIG. 4A shows two powder samples produced on different dates, labeled “pink” or “black”. The heating treatment processed at 600° C. for 2 hours and 1050° C. for another 2 hours is not enough to eliminate Cl impurities. In contrast, as shown in FIG. 2B, a higher initial temperature of 800° C. for a longer drying period of 5 hours helps to remove almost all the chlorine impurities associated with the samples. Once substantial chlorine is removed, both “pink” and “black” powders show similar phase conversion behavior.

### Example 6

### Calcination Parameters Effect on Garnet Phase Yield on Particle Size (Surface Area)

Calcination studies on two YAO powders, 2LN28D and 2LN198A, are performed in a box furnace. Four factors are studied. For each factor, three levels are considered and tested. Table 3A shows the schedule of combinations of the factors. After calcination, XRD is performed to measure the degree of phase conversion and BET to measure particle size.

Table 3B shows changes in the percentage of garnet phase formation and surface area in the YAO sample designated 2LN28D synthesized with a stoichiometry Y₃Al₅O₁₂, with processing profiles “1”-“12” defined as in Table 3A. Table 3C shows changes of percentage of garnet phase formation and surface area in a YAG sample designed 2LN198A synthesized with a stoichiometry Y₃.Al₅O₁₂ and a Y:Al integrated XRD peak intensity ratio of 1.961 in response to several of combinations of the factors with processing profiles “1”-“12” as defined in Table 3A. Calcining temperature and dwell time have the most pronounced impact on garnet phase conversion and tend to increase average particle size based on this study.

TABLE 3A
Schedule of calcination factors

| Processing | | Processing | Dwelling | Processing | | Processing | |
|---|---|---|---|---|---|---|---|
| Profile | Temperature | Profile | Time | Profile | Heating Rate | Profile | |
| Value | (° C.) | Value | (hour) | Value | (° C./minute) | Value | Mid-hold |
| 1 | 1000 | 4 | 8 | 7 | 10 | 10 | None |
| 2 | 1050 | 5 | 4 | 8 | 5 | 11 | 600° C.-2 h |
| 3 | 950 | 6 | 2 | 9 | 3 | 12 | 600° C.- |
| | | | | | | | 2 h-Cool |
| | | | | | | | down |

TABLE 3B
Effect of different factors on garnet phase mass
% conversion in YAO sample 2LN28D

| | | | | | Garnet Phase peak | |
|---|---|---|---|---|---|---|
| | Processing Profile Value | | | | intensity over | |
| Calcination | | Dwelling | Heating | | Hexagonal Phase | Surface |
| Factor | Temperature | Time | Rate | Mid-hold | peak | Area m²/g |
| T1 | 1 | 4 | 7 | 10 | 63.6 | 20.0 |
| T2 | 1 | 5 | 8 | 11 | 63.6 | 21.4 |
| T3 | 1 | 6 | 9 | 12 | 44.4 | 22.3 |
| T4 | 2 | 4 | 8 | 12 | 100 | 18.9 |
| T5 | 2 | 5 | 9 | 10 | 87.09 | 19.3 |
| T6 | 2 | 6 | 7 | 11 | 70.83 | 20.7 |
| T7 | 3 | 4 | 9 | 11 | 44.44 | 22.4 |
| T8 | 3 | 5 | 7 | 12 | 25 | 22.7 |
| T9 | 3 | 6 | 8 | 10 | 24.39 | 23.3 |

TABLE 3C
Effect of different factors on garnet phase mass %
conversion in YAO sample 2LN198A

| | | | | | Garnet Phase peak | |
|---|---|---|---|---|---|---|
| | Processing Profile Value | | | | intensity over | |
| Calcination | | Dwelling | Heating | | Hexagonal Phase | Surface |
| Factor | Temperature | Time | Rate | Mid-hold | peak | Area m²/g |
| T1 | 1 | 4 | 7 | 10 | 45.83 | 22.9 |
| T2 | 1 | 5 | 8 | 11 | 33.33 | 22.6 |
| T3 | 1 | 6 | 9 | 12 | 21.74 | 23.9 |
| T4 | 2 | 4 | 8 | 12 | 100 | 18.4 |
| T5 | 2 | 5 | 9 | 10 | 78.95 | 19.1 |
| T6 | 2 | 6 | 7 | 11 | 52.38 | 21.5 |
| T7 | 3 | 4 | 9 | 11 | 14.29 | 24.1 |
| T8 | 3 | 5 | 7 | 12 | 0 | 25 |
| T9 | 3 | 6 | 8 | 10 | 0 | 24.7 |

### Example 7

### Complete Conversion to YAG

Typical inventive YAO converts fully to the garnet structure at 1050° Celsius after dwell for 2 h. To achieve 100% garnet phase, if increasing the calcine temperature, less dwell time is needed, if reducing calcine temperature, longer dwell time is needed. Partial conversions may occur when calcination conditions are insufficient. FIG. 3B shows the XRD spectrum of the garnet structure after partial conversion occurs. Due to the rapid thermal quenching from the liquid frame combustion, YAO nanoparticles are prone to agglomerate upon necking to form a kinetically stable hexagonal phase. This hexagonal phase is thermodynamically metastable, and after calcination at a temperature, particularly above 1000° C., is wholly converted to the cubic garnet structure.

### Example 8

### Formation of Slurry for Freeze Granulation and Dry

The following components are combined to form a slurry: 35 g calcined yttrium aluminum oxide nanopowder, 65 g deionized water, 0.35 g polyvinyl alcohol, 0.5 g polyethylene glycol, 0.7 g Darvan C (polymethacrylic acid), and 0.2 g tetraethyl orthosilicate (TEOS). The slurry is ultrasonic dispersed for 20 minutes, sieved through 635 mesh, granulated through the freeze-granulator machine with liquid N₂, and then dried in the freeze-dryer machine.

### Example 9

### Formation of a Dense Green Body from Granulated Powders

Granulated powders are placed into a metal or carbide mold. 10-30 MPa pressure is applied to form parts with the desired dimension. The parts are then placed into a latex bag, to which vacuum is applied to seal the bag. The latex bag is inserted into cold-isostatic-press machine under 100-300 MPa pressure for 1-20 minutes. The relative density of resulting green body is >50%.

### Example 10

### Formation of Parts from Slip Casting Method

The following components are combined to form a slurry: 55 g calcined yttrium aluminum oxide nanopowder, 45 g deionized water, and 0.32g tetraethyl orthosilicate (TEOS) (pH 3.5-5.5). The slurry is ultrasonic dispersed for 20 minutes, sieved through 635 mesh, subjected to a vacuum chamber for 2 minutes, and then poured into gypsum mold. After 2-7 hours, dried parts are taken out of the mold. The resulting parts are then placed into humidity control chamber for further drying process. Relative density of resulting green body is >50%.

### Example 11

### Sintering of a Densified Transparent YAG Article

The parts after binder burn out are ready for sintering. The parts are buried in loose YAG powders, then sintered under vacuum <10⁻⁶ torr at 1720° C. for 4 hours. The parts are transparent after vacuum sintering. Additional hot isostatic press sintering improves the transparency of the sintered parts, at a temperature of 1700° C. for 4 hours under an atmosphere of argon at a pressure of 30 Kpsi. The resulting disk after optical polishing has dimension of 8.5 mm in diameter and 2 mm in thickness. An optical transmission spectrum collected for the disk shows a transmittance at a wavelength of 1064 nm of 83.5% transmission.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A composition comprising:
a plurality of calcined particles of yttrium aluminum oxide having a mean particle domain size of between 10 and 200 nanometers and a predominant hexagonal crystal structure.

2. The composition of claim 1 wherein each of said plurality of calcined particles contains necking on average to less than 3 neighboring particles.

3. The composition of claim 1 wherein said plurality of calcined particles have a loading of impurities that is less than 100 parts per million by weight in total for the impurity elements of: alkali earths, transition metals, and lanthanides.

4. The composition of any of claims 1 wherein said plurality of calcined particles of yttrium aluminum oxide have an atomic ratio of aluminum:yttrium of 1:0.6±0.001.

5. A composition comprising:
a plurality of particles of yttrium aluminum oxide having a mean particle domain size of between 10 and 200 nanometers and a predominant hexagonal crystal structure and an atomic ratio of aluminum:yttrium of 1:0.6±0.001.

6. The composition of claim 5 wherein said plurality of particles have a loading of impurities that is less than 100 parts per million by weight in total for the impurity elements of: alkali earths, transition metals, and lanthanides.

7. The composition of claim 3 wherein the loading of impurities is less than 55 parts per million by weight.

8. The composition of claim 3 wherein the loading of impurities of less than 55 parts per million by weight is also inclusive of B, P, K, Rb and Cs.

9. A translucent article having a surface comprising:
translucent polycrystalline yttrium aluminum garnet having an average domain size of less than 1 micron and having a density of at least 99% and inclusions present at less than 2 surface area percent, and a transmittance at a wavelength of 1064 nanometers of greater than 75%.

10. The article of claim 9 wherein said polycrystalline yttrium aluminum garnet is obtained from a composition of claim 1.

11. The article of claim 9 wherein said inclusions are present at less than 0.5 surface area percent.

12. A process for forming a translucent YAG article comprising:
calcining a composition of claim 5 at a temperature between 700° Celsius and 900° Celsius to remove organic additives to yield a predominant metastable hexagonal phase yttrium aluminum oxide nanoparticulate having an atomic ratio of aluminum:yttrium of 1:0.6±0.001;
dispersing said nanoparticulate in an organic binder; and
sintering at a temperature between 1500° Celsius and 1900° Celsius to form the translucent YAG having a transmittance at a wavelength of 1064 nanometers of greater than 75%.

13. The process of claim 12 wherein said sintering occurs under vacuum.

14. The process of claim 12 further comprising isostatic pressing during sintering and subsequent annealing and polishing.

15. A process of evaluating yttrium aluminum oxide precursor suitability to form a translucent YAG article of claim 9 comprising:
collecting an X-ray fluorescence spectrum from a plurality of aluminum oxide nanoparticles having a predominant crystal structure other than garnet to yield an Al:Y raw integrated peak intensity ratio;
sintering said plurality of yttrium aluminum oxide nanoparticles to yield a predominant garnet phase and a secondary phase and optionally isostatic pressing during sintering; and
forming the translucent YAG article only from said plurality of yttrium aluminum oxide nanoparticles having a standard deviation of ±0.003 in said peak ratio.
